(19) United States
(12) Patent Application Publication
(10) Pub. No.: US 2003/0210766 A1
(43) Pub. Date: Nov. 13, 2003

(54) Intelligent management switch with emergency calling functionality

(76) Inventors: Yu-Sheng Lin, Hsin-Chu City (TW); Xiao-Hui Jiang, Shanghai (CN)

Correspondence Address: NAIPO (NORTH AMERICA INTERNATIONAL PATENT OFFICE), P.O. BOX 506, MERRIFIELD, VA, 22116, US

(21) Appl. No.: 10/063,776

(22) Filed: May 12, 2002

(51) Int. Cl. H04M 1/24; H04M 3/08; H04M 3/22; H04M 11/04; H04M 15/00

(52) U.S. Cl. 379/33; 379/32.01; 379/37; 379/111; 379/133

(57) ABSTRACT

A management switch includes a central processing unit (CPU), network ports, a modem, an RS-232 serial port for establishing communications with a server over a serial cable or with the modem, and a memory for storing programs and data. The memory holds a network management program for analyzing network traffic on the network ports, identifying an emergency condition according to the network traffic, and generating an associated emergency condition identifier; a contact telephone number; emergency messages, and an emergency call-out program. The emergency call-out program utilizes the modem to dial the contact telephone number and send an emergency message determined by the emergency condition identifier. A switch causes the RS-232C port to communicate either with the server or with the modem.

### BACKGROUND OF INVENTION

1. Field of the Invention

The present invention relates to a management switch. More specifically, an intelligent management switch that has emergency call-out functionality is disclosed.

2. Description of the Prior Art

The explosive growth of computer networks has had a significant impact on modern life, leading to the creation of thousands of jobs to handle tasks that had heretofore been unheard of and unknown. A network manager is one such job, and various tools have been designed to help network managers in the performance of their jobs. A management switch is an example of such a tool. Please refer to FIG. 1. FIG. 1 is an environment diagram of a management switch 10 according to the prior art. The management switch 10 is used to monitor a network 12. At an intermediate level, the network 12 can include relay devices, such as a switch 12a, a hub 12b and a bridge 12c, as well as other familiar types of networking equipment. The management switch 10 has network ports 10p, which are used to connect the management switch 10 to components in the network 12. Typically, this will be the intermediate level devices 12a, 12b and 12c, as they afford the broadest possible reach for scanning network traffic. At the outermost level, the network 12 may include computers 13, servers 15 (which, in turn, may be connected, for example, to printers 15a), workstations 16, and minicomputers 14. Certainly, other network-aware devices may also be connected to the network 12. The management switch 10 is also typically connected to a dedicated server 11 through an RS-232C serial port 10r. The dedicated server 11 is used by a network manager to monitor and control the management switch 10 via a monitor 11a and I/O devices 11b (such as a mouse, keyboard, etc.). The management switch 10 has a central processing unit (CPU) 10c connected to memory 10m, and the CPU 10c executes a simple network managing protocol (SNMP) program 10s held in the memory 10m. Other program applications may also be held in the memory 10m and executed by the CPU 10c to expand the functionality of the management switch 10. For this reason, the management switch 10 is sometimes termed an intelligent management switch. The SNMP program 10s monitors the network activity on the ports 10p to detect unusual or emergency situations that may require the attention of the network manager. When such a situation arises, the SNMP program 10s informs the dedicated server 11 through the RS-232C port 10r. The dedicated server 11, in turn, will present a corresponding message on the monitor 11a, or perhaps print out a message on a printer 11p.

Under this arrangement, the management switch 10 acts somewhat like a traffic guard, monitoring, and to a certain extent controlling, the flow of the network traffic. As unusual or emergency situations arise, a corresponding message is presented on the monitor 11a, and in response to which the network manager can use the I/O devices 11b to communicate with and control the management switch 10 via commands issued by the server 11 through the RS-232C port 10r. Further, the network manager utilizes the server 11 to service the management switch 10, configuring and updating software in the memory 10m. This arrangement, however, assumes that the network manager is always in the immediate vicinity of the server 11, and so will immediately see and respond to any messages presented on the monitor 11a, or output on the printer 11p. However, this is not always the case. Frequently, a network manager will be absent from the locale of the server 11. Under such situations, when the management switch 10 detects a condition that requires the attention of the network manager, and informs the server 11 of such, a great deal of time may elapse before the network manager returns to see the corresponding message presented on the monitor 11a. In the worst-case scenario, during this interim, the network 12 may be slow, unstable or even entirely shut down.

### SUMMARY OF INVENTION

It is therefore a primary objective of this invention to provide an intelligent network management switch having an emergency calling capability to inform a user, by way of a telephone system, of a network situation that may require attention.

Briefly summarized, the preferred embodiment of the present invention discloses a management switch that provides emergency calling functionality. The management switch includes a central processing unit (CPU), network ports, a modem, an RS-232 serial port for establishing communications with a server over a serial cable or with the modem, and a memory for storing programs and data. The memory holds a network management program for analyzing network traffic on the network ports, identifying an emergency condition according to the network traffic, and generating an associated emergency condition identifier; a contact telephone number; an emergency message, and an emergency call-out program. The emergency call-out program utilizes the modem to dial the contact telephone number and send the emergency message determined by the emergency condition identifier. A switch causes the RS-232C port to communicate either with the server or with the modem.

It is an advantage of the present invention that by providing the modem, contact number and an emergency message correlated with a detected network condition, the present invention server is able to immediately contact a network manager, regardless of whether or not the network manager is in the immediate vicinity of the server. Servicing times of the network are thus reduced, leading to better over-all network performance characteristics.

It is a further advantage of the present invention that, in extreme situations where the network is totally inoperative so that the management switch is unable to communicate over the network, the management switch is still able to contact the network manager via the telephone system.

These and other objectives of the present invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is an environment diagram of a management switch according to the prior art.

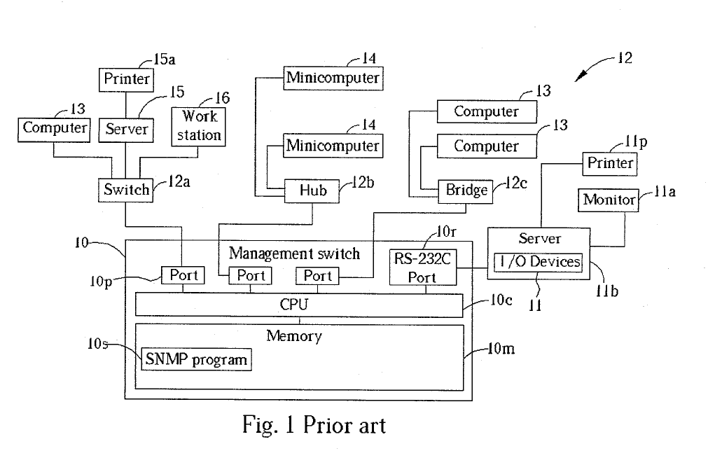

FIG. 2 an environment diagram of a management switch according to the present invention.

FIG. 3 is a block diagram of a database shown in FIG. 2.

### DETAILED DESCRIPTION

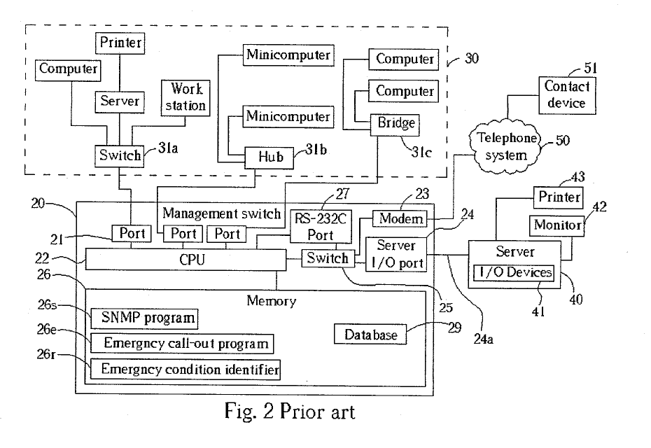

Please refer to FIG. 2. FIG. 2. is an environment diagram of an intelligent management switch 20 according to the present invention. The management switch 20 includes a plurality of ports 21, which are used to establish physical connection to a network 30 in a well-known manner. Typically, the management switch 20 will be connected to intermediate-level relay devices in the network 30, such as switches 31a, hubs 31b and bridges 31c, so as to maximize the amount of network traffic visible to the management switch 20. The management switch 20 further includes a central processing unit (CPU) 22, a modem 23, a server I/O port 24, a switch 25, memory 26 and an RS-232C port 27. The CPU 22 is electrically connected to the memory 26, the ports 21, the RS-232C port 27 and the switch 25. The switch 25 is electrically connected to the modem 23 and the server I/O port 24. Depending upon the setting of the switch 25, the switch 25 will pass signals from either the modem 23 or the server I/O port 24 to the RS-232C port 27. Hence, the switch 25 determines if the RS-232C port 27 communicates with the modem 23 or with the server I/O port 24. The server I/O port 24 is used to establish an RS-232C connection with a server 40 by way of a serial cable 24a. The server 40 has I/O devices 41, such as a mouse and keyboard, and is used by a network manager to service the management switch 20. The modem 23 is used to establish communications with a contact device 51 via a telephone system 50 in a well-known manner. The switch 25 is set by the network manager. When the network manager is in the immediate vicinity of the server 41, the network manager sets the switch to a first setting so that the RS-232C port 27 communicates via the server I/O port 24, and in this manner the network manager can use the server 40 to service the management switch 20. On the other hand, when the network manager is leaving the area of the server 40 and will be gone for some time, he or she then sets the switch 25 to a second setting so that the RS-232C port 27 communicates with the modem 23.

The memory 26 is used to hold programs and data for the CPU 22, and includes a simple network management protocol (SNMP) program 26s, an emergency call-out program 26e and a database 29. The SNMP program 26s monitors, and in some cases controls, network traffic on the ports 21, looking for any condition that may require the attention of the network manager. Such conditions could include, for example, a denial of service (DoS) attack, a suddenly incommunicative device (such as the switch 31a, hub 31b or bridge 31c going “quiet”), unusual port scans, etc. When such conditions or situations arise and are detected by the SNMP program 26s, the SNMP program 26s generates a corresponding emergency condition identifier 26r, which is stored in the memory 26. The value of the emergency condition identifier 26r indicates the unusual or emergency condition identified by the SNMP program 26s. The CPU 22 is able to determine the setting of the switch 25. If the switch 25 is in the first setting such that the RS-232C port 27 is communicating with the server 40, then the SNMP program 26s sends a message to the server 40 via the I/O server port 24, indicating the condition specified by the emergency condition identifier 26r. In response, the server 40 can generate an appropriate message on a monitor 42, or print out a message by way of a printer 43. If, however, the switch 25 is in the second setting such that the RS-232C port is in communications with the modem 23, then the CPU 22 executes the emergency call-out program 26e.

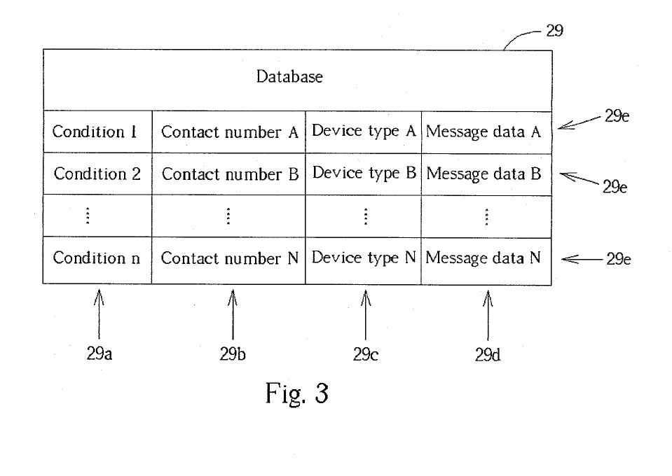

Please refer to FIG. 3 with reference to FIG. 2. FIG. 3 is a block diagram of the database 29 shown in FIG. 2. The database 29 includes a plurality of entries 29e. Each entry 29e includes a condition event 29a, which corresponds to one of the possible values of the emergency condition identifier 26r; a contact number 29b; a device type 29c, and message data 29d. Other entry-types are certainly possible, such as alternate contact numbers, alternate device types, etc. The illustrated database 29 is merely indicative of a best, minimum configuration. For an entry 29e, the contact number 29b indicates a telephone number that is to be dialed to reach a contact device 51 over the telephone system 50 when a situation as indicated by the condition event 29a arises. The device type 29c indicates the device type of the contact device 51 at the contact number 29b, which could indicate, for example, a pager access number, a modem for a remote computer, an access point for another network, a voice mailbox, a personal data assistant (PDA), cell phone, etc. Finally, the message data entry 29d holds data that is specific for the device type 29c, and which indicates the network situation that has been detected by the SNMP program 26s, as indicated by the corresponding condition event entry 29a.

When executed by the CPU 22, the emergency call-out program 26e indexes into the database 29 using the emergency condition identifier 26r to locate an entry 29e with a condition event entry 29a that corresponds to the emergency condition identifier 26r. The emergency call-out program 26e then controls the modem 23 via the RS-232C port 27 to dial the contact number 29b of the located entry 29e. Depending upon the device type 29c, the emergency call-out program 26e parses the message data 29d to control the modem 23 to leave an appropriate message at the contact device 51. For example, if the device type 29c indicates a pager service number for the contact device 51, the message data 29d will contain the pager access number for a pager of the network manager, and a numerical code indicative of the condition entry 29a, and which possibly further identifies the management switch 20. The emergency call-out program 26e controls the modem 23 to act as a simple dialer device, so that no carrier tones are generated, and parses the message data 29d to properly contact the contact device 51 (in this case, a pager access service), and leave the numerical code at the specific pager access number, by way of touch-tone dialing. At another extreme, the contact device 51 may be a network access point (i.e., via Point-to-Point protocol (PPP)). In this case, the device type 29c would indicate a PPP device, and the message data 29d would have login and password data, as well as information indicative of the condition event 29a and information for a device on the remote network to be contacted and the contact protocol to use (e-mail, instant messaging, etc.). The emergency call-out program 26e would control the modem 23 to act as a true modem, generating a carrier frequency to carry data, connecting to the contact device 51 (in this case, a PPP access number), and utilizing the message data 29d to log into the remote network to deliver a message to a device on the remote network. Hence, it should be clear that the message data 29d varies not only according to the condition entry 29a, but also according to the device type 29c. The emergency call-out program 26e must therefore parse the message data 29d according to the device type 29c. Of course, in a trivial reduction, all contact numbers 29b and device types 29c may be the same, in which case the message data 29d would vary only as a function of the condition event entry 29a.

In contrast to the prior art, the present invention provides a management switch with a modem and emergency call-out functionality to leave a message on a contact device at a predetermined contact telephone number. The contact telephone number and message can be determined by the network emergency condition identified by the management switch. Consequently, even when a network manager is not physically near a server for the management switch, the network manager can receive pertinent messages from the management switch via a telephone system and an appropriate contact device.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A network node comprising:
a central processing unit (CPU) for controlling functionality of the network node;
a plurality of network ports for establishing contact with a network over a plurality of network lines;
a modem for establishing communications with a contact device over a telephone system; and
a memory for storing programs and data, the programs executable by the CPU, the memory comprising:
a network management program for analyzing network traffic on the network ports, identifying an emergency condition according to the network traffic, and generating an associated emergency condition identifier;
at least a contact telephone number of the contact device;
at least an emergency message; and
an emergency call-out program for utilizing the modem to dial the contact telephone number and send the emergency message to the contact device according to the emergency condition identifier.

2. The network node of claim 1 further comprising:
an RS-232 serial port for establishing communications with a server over a serial cable, or with the modem; and
a switch for controlling the RS-232 port;
wherein when the switch is in a first setting the RS-232 port is capable of communicating with the server over the serial cable, and when the switch is in a second position the RS-232 port is capable of communicating with the modem.

3. The network node of claim 1 wherein the network node is a management switch.

4. The network node of claim 1 further comprising a database, the database comprising a plurality of entries, each entry comprising:
a condition event that corresponds to a possible value of the emergency condition identifier; and
corresponding message data;
the emergency call-out program containing code to index into the database according to the emergency condition identifier to locate an entry and to leave a message at the contact device according to the message data in the located entry.

5. A method for providing emergency calling functionality to a network node, the network node connected to a network and comprising a network management program for identifying an emergency condition according to traffic on the network, the method comprising:
providing the network node with a modem to connect to a telephone system;
providing at least a contact telephone number of a contact device on the telephone system;
providing at least an emergency message;
selecting a contact telephone number and an emergency message according to an emergency condition of the network as identified by the network management program; and
causing the modem to dial the contact telephone number and send the emergency message to the contact device over the telephone system.
